(19) United States
(12) Patent Application Publication
(10) Pub. No.: US 2018/0259686 A1
(43) Pub. Date: Sep. 13, 2018

(54) METHOD FOR MANUFACTURING OPTICAL LENS WITH FROSTED INTERFACE

(71) Applicant: GENIE PRECISION MACHINING CO., LTD., Taoyuan City (TW)

(72) Inventor: YU SHENG CHANG, Taichung City (TW)

(73) Assignee: GENIE PRECISION MACHINING CO., LTD., Taoyuan City (TW)

(21) Appl. No.: 15/452,300

(22) Filed: Mar. 7, 2017

(51) Int. Cl. G02B 5/02; B23K 26/00; B23K 26/53; B23K 37/04

(52) U.S. Cl. CPC G02B 5/0268; G02B 5/021; G02B 5/0236; B23K 2203/54; B23K 26/53; B23K 26/0006; B23K 37/0426; B23K 26/0057

(57) ABSTRACT

Provided is a method for manufacturing an optical lens with a frosted interface. The frosted interface is formed by laser marking between an optically effective portion and an outer portion on the optical lens. The frosted interface may resist a stray light emitted from the outer portion. This prevents the stray light from penetrating into the optically effective portion and affecting the imaging. Furthermore, also provided is a positioning structure around the optical lens. The positioning structure can help to align the optical lens and a laser instrument. Then the frosted interface can be manufactured between the optically effective portion and the outer portion accurately by the above positioning structure. The frosted interface within the optical lens enhances the imaging quality.

### BACKGROUND OF THE INVENTION

### 1. Field of the Invention

The present invention relates to a method for manufacturing an optical lens, and more particularly to a method for manufacturing an optical lens with a frosted interface.

### 2. Description of the Related Art

With reference to FIG. 5, a conventional camera lens 90 comprises multiple optical lenses 100. Each of the optical lenses 100 comprises an optical axis 101, an optically effective portion 102, and an outer portion 103. The optical axis 101 is on the center of the optical lenses 100. The optically effective portion 102 is used for imaging. The outer portion 103 is formed around an outer surface of the optically effective portion 102 and is used for stacking with neighboring optical lenses 100 and fixing the optical lenses 100 on a frame 91. A marginal light trace 104 is formed between the optically effective portion 102 and the outer portion 103. The marginal light trace 104 is a connecting line between a marginal optically effective portion a of an object-side end A and a marginal optically effective portion b of an imaging-side end B to the optical lens 100. When an external light is emitted toward the optically effective portion 102, the external light is used for imaging. When an external light is emitted toward the outer portion 103, the external light is a stray light. The stray light may affect the imaging clarity of the optical lenses 100. The marginal light trace 104 of the optical lenses 100 is a bordering line to determine whether an external light is used for imaging or not.

The marginal light trace 104 is a transparent interface. After an external light is emitted into the outer portion 103, the external light may be reflected back and forth in the outer portion 103 and then penetrate into the optically effective portion 102 through the marginal light trace 104. Finally, the external light may become a stray light for the optically effective portion 102. The stray light can interfere with a light directly emitted into the optically effective portion 102 and affect the clarity of imaging. Furthermore, the stray light may also induce ghost to the imaging.

With reference to FIG. 6, there are lens baffles 110 mounted between adjacent outer portions 103A of neighboring optical lenses 100A in a conventional camera lens 90A. The lens baffles 110 may prevent an external light from emitting into the outer portions 103A and then penetrating into the optically effective portion 102A to disturb the imaging. The lens baffles 110 can block the external light into the optically effective portion 102A from the outer portions 103A. Furthermore, the lens baffles 110 can reduce a ratio between the external light penetrating into the optically effective portion 102A and the external light emitted into the outer portions 103A. The interference with the imaging from the external light may be reduced by the lens baffles 110.

With reference to FIG. 7, there are rugged regions 120 which are manufactured on the surface of the outer portions 103B between adjacent outer portions 103B of neighboring optical lenses 100B in a conventional camera lens 90B. The rugged regions 120 are manufactured by abrasive blasting process or electrical discharge machining process. The rugged regions 120 may also prevent an external light from emitting into the outer portions 103B and then penetrating into the optically effective portion 102B to interfere with the imaging. The rugged regions 120 can absorb the external light emitted from the outer portions 103B. The rugged regions 120 reduce the external light penetrating into the optically effective portion 102B from the outer portions 103B through the marginal light trace 104B. The interference with the imaging or the ghost caused by the external light may be reduced by the rugged regions 120.

However, the above lens baffles 110 between the neighboring optical lenses 100A in the conventional camera lens 90A may make widths of air gaps between the neighbor optical lenses 100A vary from one another. The above rugged regions 120 manufactured by abrasive blasting process or electrical discharge machining process also vary with different depths and heights, further resulting in the varying widths of the air gaps between the neighbor optical lenses 100B in the conventional camera lens 90B. These problems may hinder effective blocking of the external light from penetrating into the optically effective portion 102A, 102B from the outer portions 103A, 103B. The imaging qualities of the conventional camera lens 90A, 90B are weakened.

Furthermore, the above abrasive blasting process and electrical discharge machining process can only work on the surface of the optical lenses 100B. The abrasive blasting process and electrical discharge machining process cannot work on the interior of the optical lenses 100B. How to overcome interferences with imaging by the stray light from the outer portions 103A, 103B is still a big issue to be resolved.

### SUMMARY OF THE INVENTION

An objective of the present invention is to provide a method for manufacturing optical microstructures, not only on the surface of the optical lens but also inside the optical lens. The optical microstructures formed inside of the optical lens may prevent a stray light directly penetrating into the optically effective portion of the optical lens from the outer portion of the optical lens. This may enhance the imaging clarity of the optical lens.

To achieve the foregoing objective, the present invention provides a method for manufacturing an optical lens with a frosted interface, the method comprising aligning a marginal light trace between an optically effective portion and an outer portion of an optical lens to a laser instrument and forming a frosted interface on the marginal light trace by a laser beam induced from the laser instrument. The marginal light trace is a connecting line between a marginal optically effective portion of an object-side end and a marginal optically effective portion of an imaging-side end of the optical lens.

The advantage of the present invention is utilizing the laser to laser-mark the interior of the optical lens. Then the frosted interface is formed on the marginal light trace inside the optical lens. The frosted interface may reduce light penetrating into the optically effective portion from the outer portion. The frosted interface may reduce the interference of stray light from the outer portion, hence enhancing clarity and imaging quality.

Particularly, before aligning the marginal light trace between the optically effective portion and the outer portion of the optical lens to the laser instrument, the method comprises providing a positioning structure around the optical lens. The positioning structure comprises multiple connecting blocks and at least one positioning member. The multiple connecting blocks are mounted on an outer surface of the optical lens, and the at least one positioning member connects to sides of the multiple connecting blocks that are distal from the optical lens. The advantage of the present invention is utilizing the positioning structure around the optical lens to help regulate the alignment of the optical lens and the laser instrument.

More particularly, after forming the frosted interface on the marginal light trace by the laser beam induced from the laser instrument, the method comprises separating the optical lens and the positioning structure. The advantage of the present invention is further utilizing cutting to separate the optical lens and the positioning structure. Then the optical lens with the frosted interface may be produced.

More particularly, the multiple connecting blocks, the at least one positioning member, and the optical lens are integrated. The advantage of the present invention is integrating the positioning structure and the optical lens to avoid a margin tolerance among the optical lens, the multiple connecting blocks, and the at least one positioning member. This also prevents the margin tolerance among the optical lens, the multiple connecting blocks, and the at least one positioning member from influencing the alignment between the optical lens and the laser instrument. The frosted interface may be formed accurately on the marginal light trace of the optical lens.

More particularly, a number of the multiple connecting blocks is four, which is only an example. The number of the multiple connecting blocks is not limited to four.

More particularly, the at least one positioning member is a ring that comprises an inner edge and an outer edge. The inner edge connects to the sides of the multiple connecting blocks that are distal from the optical lens.

More particularly, the at least one positioning member is multiple balls. A number of the at least one positioning member is equal to the number of the multiple connecting blocks. The at least one positioning member each respectively connects to the multiple connecting blocks at the sides of the connecting blocks that are distal from the optical lens.

### BRIEF DESCRIPTION OF THE DRAWINGS

FIG. 1 is a perspective view of the optical lens, the connecting blocks, and the positioning member in accordance with Embodiment 1 of the present invention;

FIG. 2 is a schematic view of forming a frosted interface on the optical lens by laser marking;

FIG. 3 is a schematic view of separating the optical lens from the positioning structure;

FIG. 4 is a perspective view of the optical lens, the connecting blocks, and the positioning member in accordance with Embodiment 2 of the present invention;

FIG. 5 is a schematic view of the optical lens mounted in the conventional camera lens;

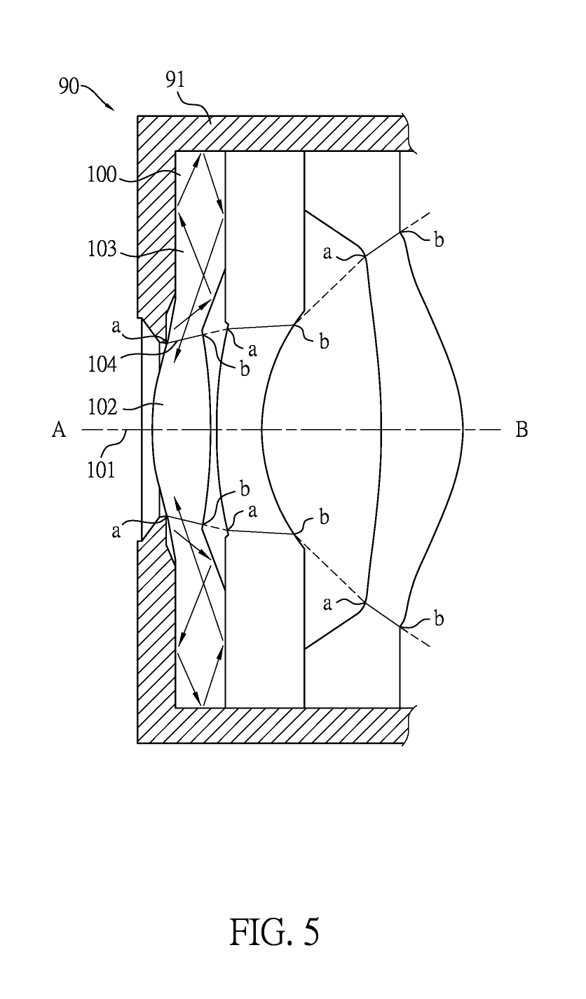

FIG. 6 is a schematic view of the optical lens and lens baffle mounted in the conventional camera lens; and

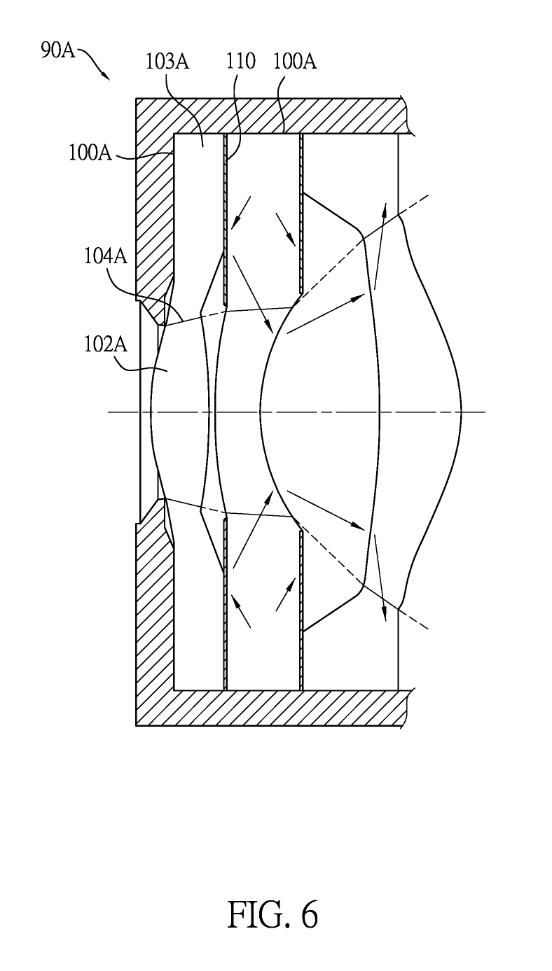

FIG. 7 is a schematic view of the optical lens and rugged region mounted in the conventional camera lens.

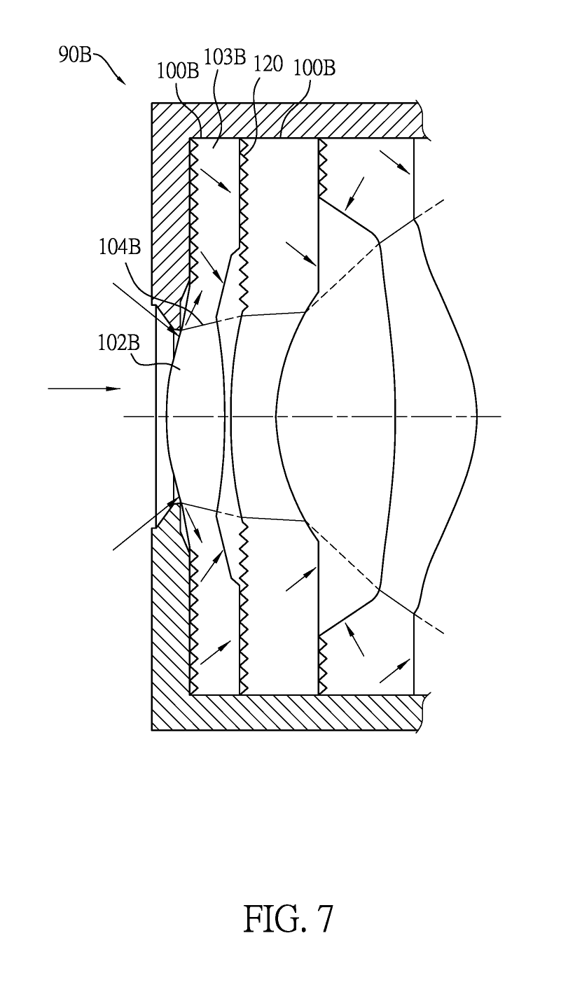

### DETAILED DESCRIPTION OF THE INVENTION

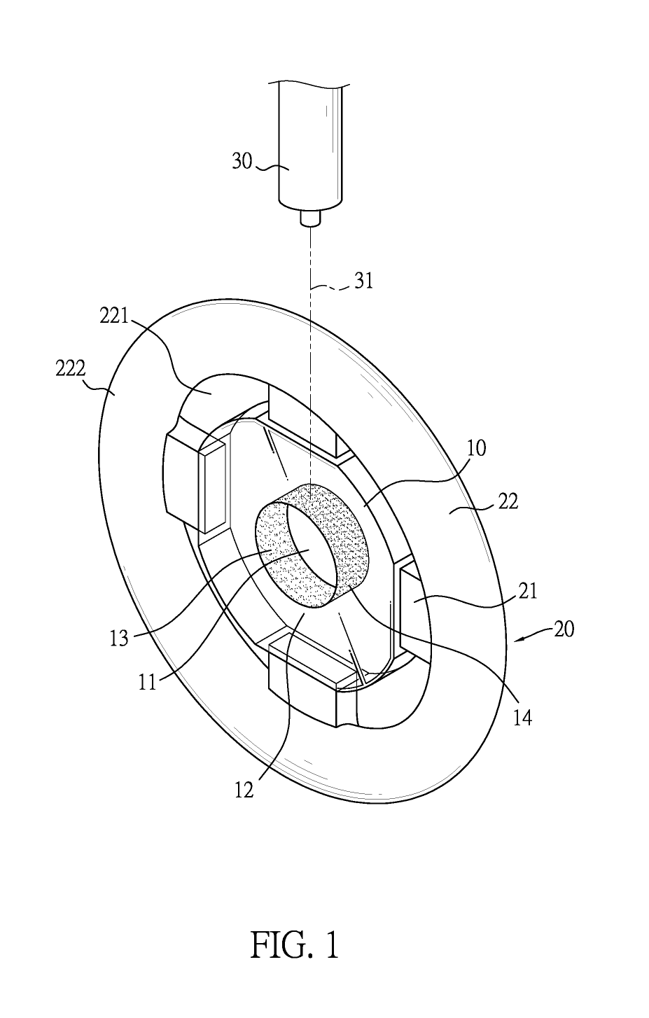

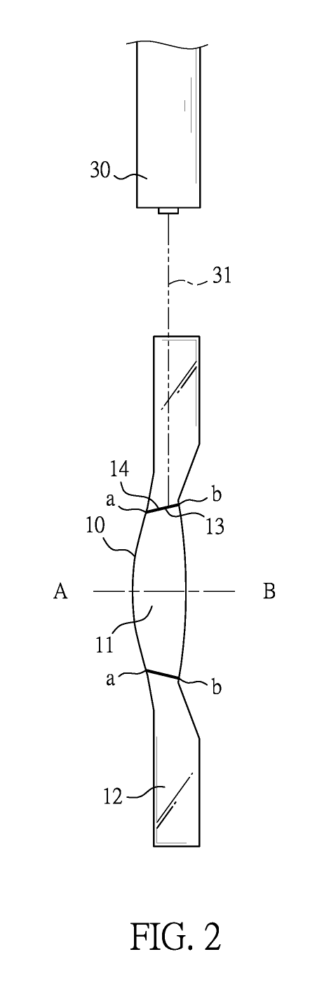

With reference to FIGS. 1 and 2, a first embodiment of the present invention provides a positioning structure 20 around an optical lens 10. The optical lens 10 comprises an optically effective portion 11 and an outer portion 12. The positioning structure 20 comprises four connecting blocks 21 and a positioning member 22. The four connecting blocks 21 are mounted on an outer surface of the outer portion 12 at spaced intervals. The positioning member 22 connects to the four connecting blocks 21 at sides of the connecting blocks that are distal from the outer portion 12 of the optical lens 10. The optical lens 10, the four connecting blocks 21, and the positioning member 22 are integrated. The positioning member 22 is a ring. The positioning member 22 comprises an inner edge 221 and an outer edge 222. The inner edge 221 connects to the four connecting blocks 21 at the sides of the four connecting blocks that are distal from the outer portion 12 of the optical lens 10.

After the above the optical lens 10 and the positioning structure 20 are fixed, a marginal light trace 13 between the optically effective portion 11 and the outer portion 12 of the optical lens 10 is aligned to a laser instrument 30. The marginal light trace 13 is a connecting line between a marginal optically effective portion a of an object-side end A and a marginal optically effective portion b of an imaging-side end B of the optical lens 10. The laser instrument 30 may induce a laser beam 31 to laser-mark a side of the marginal light trace 13 toward the outer portion 12 of the optical lens 10. A frosted interface 14 is formed on the marginal light trace 13 toward the outer portion 12 of the optical lens 10 by the above laser marking.

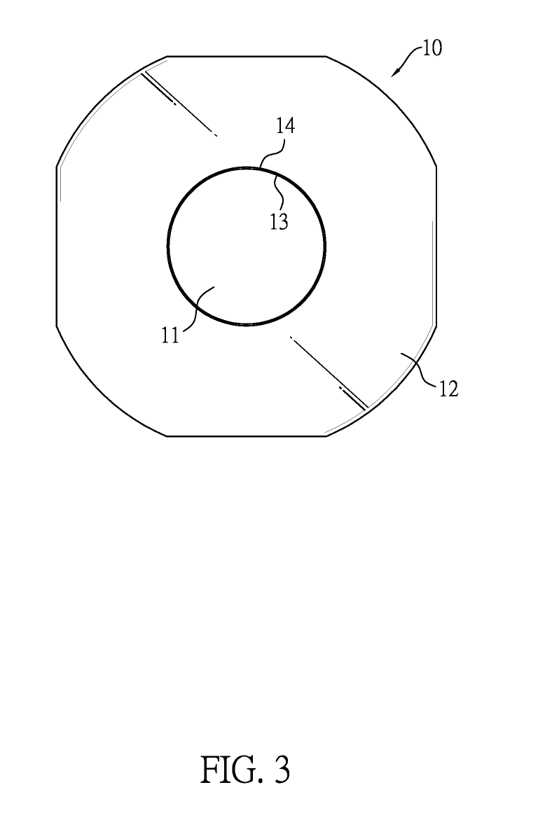

After the above frosted interface 14 is formed on the marginal light trace 13, the optical lens 10 and the positioning structure 20 are separated by cutting. Then the optical lens 10 and the four connecting blocks 21 are separated. The optical lens 10 with the frosted interface 14 is produced as shown in FIG. 3.

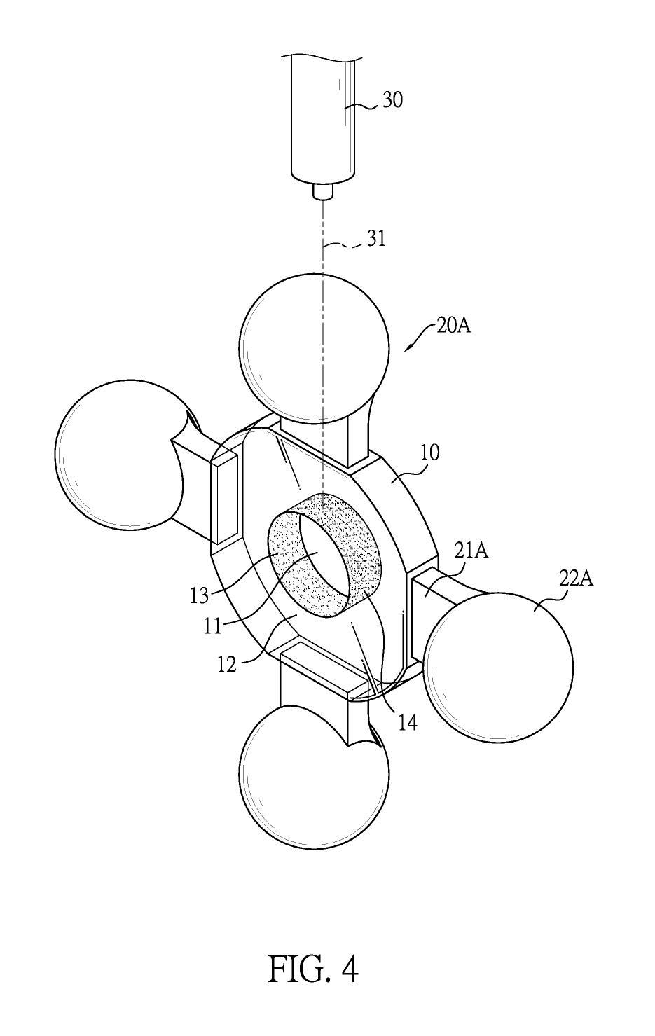

With reference to FIG. 4, a second embodiment of the present invention provides a positioning structure 20A around an optical lens 10. The optical lens 10 comprises an optically effective portion 11 and an outer portion 12. The positioning structure 20A comprises four connecting blocks 21A and four positioning members 22A. The four connecting blocks 21A are mounted on the outer surface of the outer portion 12 at spaced intervals. The four positioning members 22A each respectively connect to the four connecting blocks 21A at the sides of the four connecting blocks 21A that are distal from the outer portion 12 of the optical lens 10. The positioning members 22A are balls. The optical lens 10, the four connecting blocks 21 A, and the four positioning members 22 A are integrated.

After the above the optical lens 10 and the positioning structure 20A are fixed, a marginal light trace 13 between the optically effective portion 11 and the outer portion 12 of the optical lens 10 are aligned to a laser instrument 30. The laser instrument 30 may induce a laser beam 31 to laser-mark a side of the marginal light trace 13 toward the outer portion 12 of the optical lens 10. A frosted interface 14 is formed on the marginal light trace 13 toward the outer portion 12 of the optical lens 10 by the above laser marking.

After the above frosted interface 14 is formed on the marginal light trace 13, the optical lens 10 and the positioning structure 20A are separated by cutting. Then the optical lens 10 and the four connecting blocks 21A are separated. The optical lens 10 with the frosted interface 14 is produced.

In summary, the method of the present invention not only foiins a frosted interface 14 by laser marking on the marginal light trace 13, but also prevents a stray light penetrating through the marginal light trace 13 from entering into the optically effective portion 11 and disturbing the imaging. The method of the present invention may also help align the optical lens 10 and the laser instrument 30. Then the laser beam 31 induced from the laser instrument 30 may target the marginal light trace 13 of the optical lens 10 accurately for laser marking. The method of the present invention ensures that the frosted interface 14 may be formed on the marginal light trace 13 more accurately, thereby providing the optical lens 10 with high quality imaging.

What is claimed is:

1. A method for manufacturing an optical lens with a frosted interface comprising:
aligning a marginal light trace between an optically effective portion and an outer portion of an optical lens to a laser instrument; and
forming a frosted interface on the marginal light trace by a laser beam induced from the laser instrument.

2. The method as claimed in claim 1, wherein before aligning the marginal light trace between the optically effective portion and the outer portion of the optical lens to the laser instrument, the method comprises providing a positioning structure around the optical lens; the positioning structure comprises multiple connecting blocks and at least one positioning member; the multiple connecting blocks are mounted on an outer surface of the optical lens, and the at least one positioning member connects to the multiple connecting blocks at sides of the connecting blocks that are distal from the optical lens.

3. The method as claimed in claim 2, wherein after forming the frosted interface on the marginal light trace by the laser beam induced from the laser instrument, the method comprises separating the optical lens and the positioning structure.

4. The method as claimed in claim 2, wherein the multiple connecting blocks and the optical lens are integrated.

5. The method as claimed in claim 3, wherein the multiple connecting blocks and the optical lens are integrated.

6. The method as claimed in claim 4, wherein the at least one positioning member and the multiple connecting blocks are integrated.

7. The method as claimed in claim 2, wherein the at least one positioning member is a ring that comprises an inner edge and an outer edge; the inner edge connects to the sides of the multiple connecting blocks that are distal from the optical lens.

8. The method as claimed in claim 3, wherein the at least one positioning member is a ring that comprises an inner edge and an outer edge; the inner edge connects to the sides of the multiple connecting blocks that are distal from the optical lens.

9. The method as claimed in claim 2, wherein the at least one positioning member is multiple balls; a number of the at least one positioning member is equal to a number of the multiple connecting blocks; the at least one positioning member each respectively connects to the multiple connecting blocks at the sides of the multiple connecting blocks that are distal from the optical lens.
